(19) United States
(12) Patent Application Publication
(10) Pub. No.: US 2017/0089276 A1
(43) Pub. Date: Mar. 30, 2017

(54) CONTROL SYSTEM OF TURBOCHARGED ENGINE

(71) Applicant: Mazda Motor Corporation, Aki-gun (JP)

(72) Inventors: Yugou Sunagare, Hiroshima-shi (JP); Takafumi Nishio, Otake-shi (JP); Chikako Ohisa, Aki-gun (JP); Masayoshi Higashio, Hiroshima-shi (JP)

(21) Appl. No.: 15/256,129

(22) Filed: Sep. 2, 2016

(30) Foreign Application Priority Data
Sep. 25, 2015 (JP) 2015-188755

(51) Int. Cl. F02D 41/00; F02B 39/16; F02M 35/10; F02D 41/10

(52) U.S. Cl. CPC F02D 41/0007; F02D 41/10; F02B 39/16; F02M 35/10157; F02M 35/10373; F02D 2200/602

(57) ABSTRACT

A control system of a turbocharged engine is provided, which includes a turbocharger having a compressor disposed in an intake passage, a bypass passage for bypassing the compressor in the intake passage, and a bypass valve provided to the bypass passage and for opening and closing the bypass passage. The control system includes a processor configured to execute a surge estimating module for estimating an occurrence of a surge, a bypass valve controlling module for opening the bypass valve when the surge estimating module estimates that the surge occurs, and a target air charge amount setting module for suppressing, when the bypass valve controlling module opens the bypass valve, a reduction of a target air charge amount until the opening operation of the bypass valve completes.

### BACKGROUND

The present invention relates to a control system of a turbocharged engine, particularly to a control system of a turbocharged engine which includes a bypass passage for bypassing a compressor in an intake passage.

For turbocharged engines, a turbine of a turbocharger is disposed in an exhaust passage, and a compressor of the turbocharger is disposed in an intake passage. The turbine is rotated by an exhaust flow discharged from a combustion chamber of the engine, and the compressor directly coupled to the turbine is rotated thereby. As a result, a supply amount of air to the combustion chamber is increased. In this type of turbocharger, a so-called surge easily occurs, especially during deceleration of the engine.

FIG. 14 is a compressor map indicating an operable area of the compressor. The compressor map has a surging line L, and a range on a lower flow rate side of the surging line L is a surging range. In a case where an operating point P0 which is plotted based on a flow rate through the compressor and a pressure ratio between positions upstream and downstream of the compressor (hereinafter, referred to as the “compressor pressure ratio”) is located within the surging range, a surge occurs in which an intake flow vibrates to upstream and downstream sides of the intake passage while causing abnormal noise.

For example, when a throttle valve provided in the intake passage is closed during deceleration, although the exhaust flow supplied to the turbine decreases, the turbine continues to rotate for a while due to an inertial force. Thus, the compressor coupled to the turbine also continues to turbocharge. As a result, the turbocharged air discharged from the compressor to the downstream side thereof is blocked by the throttle valve, and pressure between the compressor and the throttle valve is maintained for a while. On the other hand, the compressor flow rate decreases since the throttle valve is closed.

In other words, the compressor flow rate decreases while the compressor pressure ratio is kept high. Here, the operating point of the compressor easily shifts to the surging range, which causes a surge.

To suppress an occurrence of the surge, it is known to provide, to the intake passage, a bypass passage for bypassing the compressor, and a bypass valve for opening and closing the bypass passage. For example, JP2003-097298A discloses an art in which, during deceleration of an engine, i.e., when a throttle valve is closed, by opening a bypass valve, pressure between a compressor and the throttle valve is released to an upstream side of the compressor via the bypass passage. Thus, a compressor pressure ratio is reduced and the occurrence of the surge is suppressed.

The bypass valve of JP2003-097298A is opened when pressure downstream of the throttle valve becomes negative. In other words, the bypass valve is opened when the throttle valve is closed (e.g., during deceleration).

Meanwhile, there is a case where the surge does not occur even when the bypass valve is not opened during the deceleration. For example, in a case where the operating point is sufficiently separated to the higher flow rate side from the surging line L (e.g., an operating point P1 in FIG. 14), the inertial force of the turbine is weakened and the compressor pressure ratio decreases while the compressor flow rate decreases after the deceleration. Therefore, the operating point may not reach the surging range.

Further, even in a case where the operating point is not sufficiently separated to the higher flow rate side from the surging line L (e.g., an operating point P2), if the engine speed is accelerated again after the deceleration (hereinafter, referred to as the “second acceleration”) but before reaching the surging range, the operating point does not reach the surging range even if the bypass valve is not opened.

Specifically, if the bypass valve is opened every time the engine speed is decelerated even for the above case, the turbocharging pressure between the compressor and the throttle valve drops, and, therefore, it takes time to increase the dropped turbocharging pressure in the second acceleration. As a result, an acceleration response degrades.

On the other hand, it can be considered to estimate an occurrence of the surge based on an operating status of the compressor and open the bypass valve when the surge is estimated to occur. However, it is not easy to estimate the occurrence of the surge. Even if it can be estimated, an operation delay (response delay) accompanies the opening of the bypass valve. Therefore, the bypass valve is not opened by the occurring timing of the surge which is immediately after the estimation, and it is difficult to prevent the surge.

### SUMMARY

The present invention is made in view of solving the above problems, and aims to provide a method and system for controlling a turbocharged engine, which is capable of improving an acceleration response of the engine by preventing a bypass valve from being opened unnecessarily, while preventing a surge which occurs due to a delay in opening the bypass valve.

According to one aspect of the present invention, a control system of a turbocharged engine is provided, which includes a turbocharger having a compressor disposed in an intake passage, a bypass passage for bypassing the compressor in the intake passage, and a bypass valve provided to the bypass passage and for opening and closing the bypass passage. The control system includes processor configured to execute a surge estimating module for estimating an occurrence of a surge, a bypass valve controlling module for opening the bypass valve when the surge estimating module estimates that the surge occurs, and a target air charge amount setting module for suppressing, when the bypass valve controlling module opens the bypass valve, a reduction of a target air charge amount until the opening operation of the bypass valve completes.

With the above configuration, since the bypass valve is opened when the surge is estimated to occur, the bypass valve is prevented from being opened unnecessarily and a turbocharging pressure is easily kept. Further, until the opening operation of the bypass valve completes, for example even during deceleration of the engine, since the reduction of the target air charge amount is suppressed, a reduction of a flow rate through the compressor can be suppressed, and this can prevent an operating point of the compressor from being located within a surging range. In other words, even while preventing the surge caused by a delay of the opening operation of the bypass valve, an acceleration response can be improved by preventing the bypass valve from being opened unnecessarily.

For example, a target opening of a throttle valve is set based on the target air charge amount, and the air charge amount is adjusted by changing a flow path area of the intake passage at the position of the throttle valve.

The processor may be further configured to execute a throttle valve opening estimating module for estimating an opening of a throttle valve for after a predetermined period of time from a current timing based on a target opening of the throttle valve that is set corresponding to an acceleration request from a driver, a throttle valve upstream-downstream pressure estimating module for estimating a pressure at a position upstream of the throttle valve and a pressure at a position downstream of the throttle valve, for after the predetermined time period, a throttle valve flow rate estimating module for estimating a flow rate through the throttle valve for after the predetermined time period, based on the estimated opening of the throttle valve and the estimated pressures at the positions upstream and downstream of the throttle valve, a compressor flow rate estimating module for acquiring the estimated throttle valve flow rate as a flow rate through the compressor, and a compressor pressure ratio detecting module for detecting a pressure ratio between positions upstream and downstream of the compressor. The surge estimating module may estimate the occurrence of the surge according to surge determination data based on the estimated compressor flow rate and the detected compressor pressure ratio.

With the above configuration, whether the surge occurs after the predetermined time period can easily be estimated based on the estimated compressor flow rate for after the predetermined time period and the compressor pressure ratio for the current timing. Here, by considering that the compressor pressure ratio is maintained for a while even during the deceleration due to an inertia force of a turbine, the surge after the predetermined time period can be estimated using the compressor pressure ratio for the current timing.

Further, the compressor flow rate for after the predetermined time period can easily be estimated based on the estimated throttle valve opening and the estimated pressures at the positions upstream and downstream of the throttle valve.

For example, the estimated throttle valve opening is obtained as an actual opening based on the target opening thereof set corresponding to the acceleration request from the driver, according to dynamic characteristics data of the throttle valve acquired in advance. The pressure at the position upstream of the throttle valve is estimated based on a pressure at the position upstream of the throttle valve at the current timing detected by a pressure sensor. The pressure at the position downstream of the throttle valve is estimated based on a current operating state of the engine according to a volumetric efficiency estimation map acquired in advance.

Executing the target air charge amount setting module may suppress the reduction of the target air charge amount by setting a lowest value of the target air charge amount.

With the above configuration, the reduction of the target air charge amount can easily be suppressed by setting the lowest value of the target air charge amount.

The lowest value may correspond to a flow rate that is the same as or above a surging flow rate obtained according to surge determination data, based on a compressor pressure ratio.

With the above configuration, since the lowest value corresponds to the flow rate that is the same as or above the surging flow rate at the compressor pressure ratio for the current timing, the compressor can be prevented from operating on a lower flow rate side of a surging line, and therefore, the surge can surely be suppressed.

Note that the surge determination data is, for example, the surging line indicating a relationship between the compressor flow rate and the compressor pressure ratio, and set in advance for every compressor pressure ratio, as a smallest air amount at which the surge does not occur.

The lowest value may correspond to a flow rate that is 1.2 times the surging flow rate.

With the above configuration, since the lowest value corresponds to the flow rate that is 1.2 times the surging flow rate, it is not set excessively high. Thus, a degradation of a deceleration sensation during the deceleration can be suppressed. Additionally, since there is an allowance on a higher flow rate side of the surging line, even in consideration of a variation in the surging line of the individual compressor due to the manufacturing process/conditions, change in condition over time, etc., the compressor operating point is still located on the higher flow rate side of the surging line, and therefore, the surge is surely prevented.

According to another aspect of the present invention, a control system of a turbocharged engine is provided, which includes a turbocharger having a compressor disposed in an intake passage, a bypass passage for bypassing the compressor in the intake passage, and a bypass valve provided to the bypass passage and for opening and closing the bypass passage. The control system includes a processor configured to execute a surge estimating module for estimating an occurrence of a surge, a bypass valve controlling module for opening the bypass valve when the surge estimating module estimates that the surge occurs, and a target air charge amount setting module for setting a target air charge amount based on an operation of an accelerator pedal performed by a driver, and suppressing, when the bypass valve controlling module opens the bypass valve, a reduction of the target air charge amount caused when the operation of the accelerator pedal is changed, until the opening operation of the bypass valve completes, the operation of the accelerator pedal detected by an accelerator pedal opening sensor.

According to another aspect of the present invention, a control system of a turbocharged engine is provided, which includes a turbocharger having a compressor disposed in an intake passage, a bypass passage for bypassing the compressor in the intake passage, and a bypass valve provided to the bypass passage and for opening and closing the bypass passage. The control system includes a processor configured to execute a surge estimating module for estimating an occurrence of a surge, a bypass valve controlling module for opening the bypass valve when the surge estimating module estimates that the surge occurs, and a target air charge amount setting module for setting a target air charge amount based on an operation of an accelerator pedal performed by a driver, and suppressing, when the bypass valve controlling module opens the bypass valve, a reduction of the target air charge amount caused during deceleration of the engine, until the opening operation of the bypass valve completes, the operation of the accelerator pedal detected by an accelerator pedal opening sensor.

### BRIEF DESCRIPTION OF THE DRAWINGS

FIG. 1 is a block diagram schematically illustrating a turbocharging system of a turbocharged engine according to a first embodiment of the present invention.

FIG. 2 is a block diagram illustrating a control system according to the first embodiment.

FIG. 3 is a flowchart illustrating an operation of the control system of FIG. 2.

FIG. 4 is a flowchart illustrating a subroutine for estimating a flow rate through a compressor.

FIGS. 5A to 5C are charts illustrating operations relating to a bypass valve of the control system of FIG. 2.

FIGS. 6A to 6C are charts illustrating other operations of FIGS. 5A to 5C.

FIGS. 7A to 7E are charts illustrating operations relating to a throttle valve of the control system of FIG. 2.

FIG. 8 is a block diagram illustrating a control system according to a second embodiment.

FIG. 9 is a flowchart illustrating an operation of the control system of FIG. 8.

FIG. 10 is a flowchart illustrating a subroutine for estimating a flow rate through a compressor.

FIG. 11 is a block diagram illustrating a control system according to a third embodiment.

FIG. 12 is a flowchart illustrating an operation of the control system of FIG. 11.

FIGS. 13A to 13E are charts illustrating operations of the control system of FIG. 11.

FIG. 14 is a schematic chart of a compressor map.

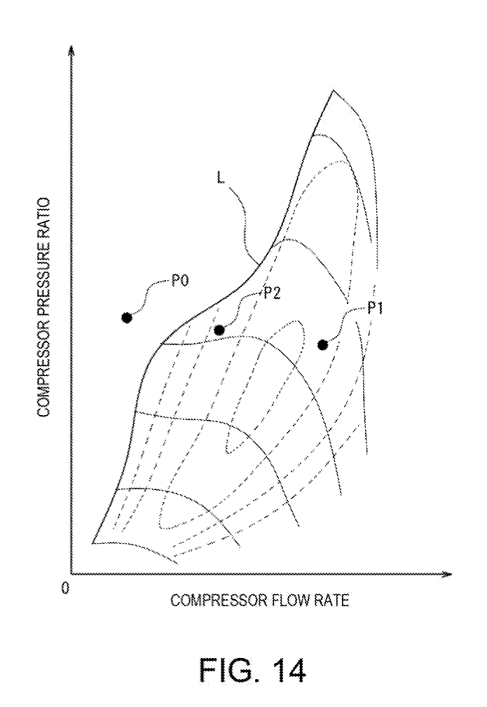

### DETAILED DESCRIPTION OF EMBODIMENTS

Hereinafter, a turbocharging system of a turbocharged engine according to embodiments of the present invention is described with reference to the appended drawings.

### First Embodiment

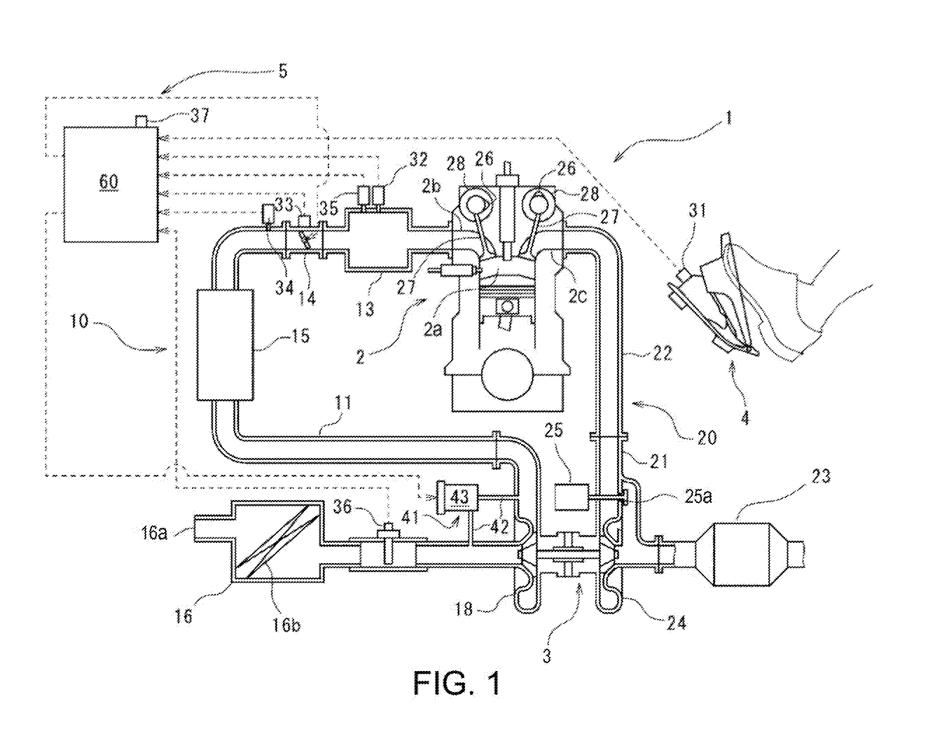

The turbocharging system of the turbocharged engine of a first embodiment includes a bypass passage provided in an intake passage and for bypassing a compressor, and a bypass valve provided in the bypass passage and for opening and closing the bypass passage. A surge which occurs in the intake passage when a throttle valve is closed during deceleration of the engine is reduced by opening the bypass valve. FIG. 1 is a block diagram schematically illustrating the turbocharging system 1 of the turbocharged engine according to the first embodiment of the present invention.

The turbocharging system 1 is mounted on a vehicle and, as illustrated in FIG. 1, includes the engine 2, an intake system 10, an exhaust system 20, an accelerator pedal device 4, and a controller 5. The engine 2 is a gasoline engine and includes a plurality of cylinders, and a camshaft 26 provided with a Variable Valve Timing (VVT) 28 for variably controlling opening timings of intake and exhaust valves 27 according to an operating state of the engine. A combustion chamber 2a of each cylinder of the engine 2 is connected with the intake system 10 via an intake port 2b, and is connected with the exhaust system 20 via an exhaust port 2c.

The intake system 10 includes an intake passage 11. In the intake passage 11, an air cleaner 16, a compressor 18 of a turbocharger 3, an intercooler 15, a throttle valve 14, and an intake manifold 13 are arranged in this order from an upstream side. The intake system 10 takes in outside air (intake air) through an air suction port 16a of the air cleaner 16 and supplies it to the compressor 18 through a filter 16b. Then, the air is turbocharged by the compressor 18, cooled by the intercooler 15, adjusted in flow rate by the throttle valve 14, and then supplied to the combustion chamber 2a of each cylinder via the intake manifold 13.

In the intake passage 11, an airflow sensor 36 is disposed between the air cleaner 16 and the compressor 18. The airflow sensor 36 detects an amount of intake air sucked in from the air suction port 16a. As the airflow sensor 36, for example, an airflow sensor of a hot wire type or a Karman-Vortex type is adopted.

Further, in the intake passage 11, a pressure sensor 34 is disposed between the intercooler 15 and the throttle valve 14, and an intake manifold pressure sensor 32 and a temperature sensor 35 are disposed in the intake manifold 13. The pressure sensor 34 detects pressure inside the intake passage 11, between the intercooler 15 and the throttle valve 14. The intake manifold pressure sensor 32 detects pressure inside the intake manifold 13 and the temperature sensor 35 detects a temperature inside the intake manifold 13.

The throttle valve 14 is electronically controlled so as to open and close based on a control signal from the controller 5, according to a pedal depressing operation performed by a driver of the vehicle and detected by an accelerator pedal opening sensor 31 of the accelerator pedal device 4. The throttle valve 14 adjusts a supply amount of the air to the combustion chambers 2a by changing a flow path area of the intake passage 11. The throttle valve 14 is provided with a throttle valve opening sensor 33 for detecting an opening of the throttle valve 14.

Further in the intake passage 11, an intake recirculation device 41 for recirculating a part of the intake air turbocharged by the compressor 18, back to the upstream side of the compressor 18. The intake recirculation device 41 includes a bypass passage 42 and a bypass valve 43.

One end of the bypass passage 42 opens to a position of the intake passage 11 between the airflow sensor 36 and the compressor 18, and the other end of the bypass passage 42 opens to a position of the intake passage 11 between the compressor 18 and the intercooler 15. The bypass valve 43 is provided in the bypass passage 42 and electronically controlled so as to open and close based on a control signal from the controller 5.

The turbocharger 3 includes the compressor 18 disposed in the intake passage 11, a turbine 24 disposed in an exhaust passage 21, and a wastegate actuator 25. In the turbocharger 3, the turbine 24 is rotated by an exhaust flow discharged from the engine 2, and the compressor 18 directly and coaxially coupled to the turbine 24 is rotated thereby. As a result, the intake air is turbocharged in the intake passage 11.

The wastegate actuator 25 releases a part of the exhaust flow discharged from the engine 2, to a downstream side of the turbine 24 by bypassing the turbine 24 via an exhaust bypass passage 25a communicating the upstream and downstream sides of the turbine 24 with each other.

In the exhaust passage 21, an exhaust manifold 22, the turbine 24 of the turbocharger 3, and an exhaust pipe 23 are arranged in this order from the upstream side.

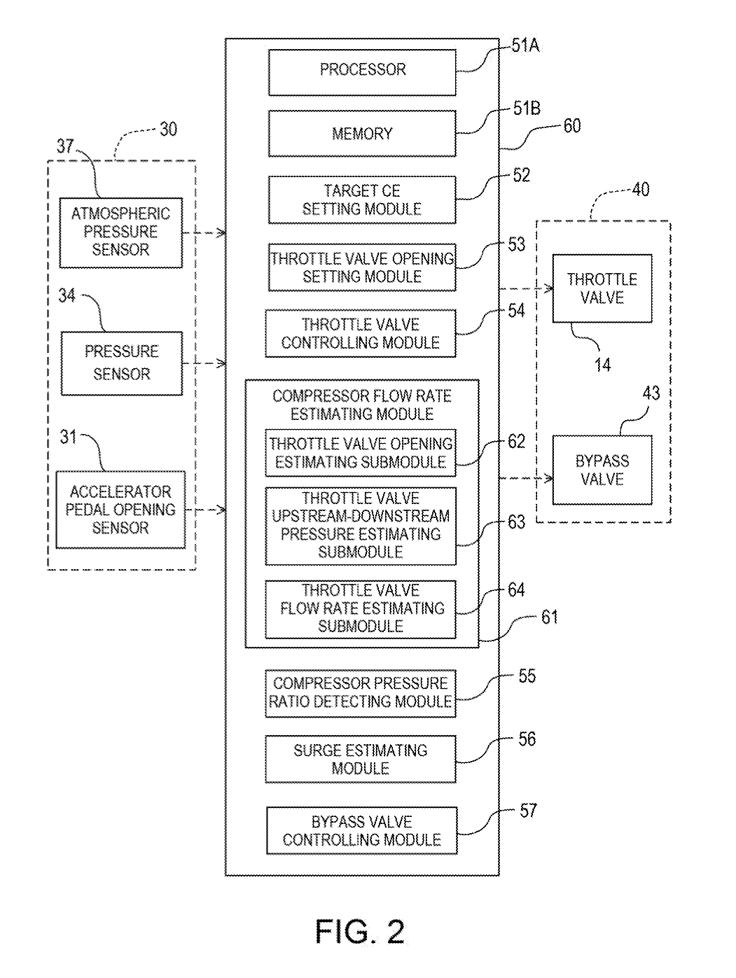

Next, the controller 5 is described with reference to a block diagram illustrated in FIG. 2. The controller 5 includes an input device 30, a control device 60, and an output device 40. The control device 60 estimates whether a surge will occur after a predetermined period of time from a current timing by estimating an operating status of the compressor 18 after the predetermined time period based on signals from the input device 30, and controls an operation of the output device 40 based on the estimated result.

The input device 30 includes the accelerator pedal opening sensor 31, the pressure sensor 34, and an atmospheric pressure sensor 37. The atmospheric pressure sensor 37 is attached to the control device 60 (see FIG. 1). The output device 40 includes the throttle valve 14 and the bypass valve 43.

The control device 60 includes a processor 51A, a memory 51B, a target air charge amount setting module (target CE setting module) 52, a throttle valve opening setting module 53, a throttle valve controlling module 54, a compressor flow rate estimating module 61, a compressor pressure ratio detecting module 55, and a surge estimating module 56, and a bypass valve controlling module 57.

The processor 51A is configured to execute the various software modules of the control device 60 in order to effect the control functions of the controller 5. The memory 51B stores required data for controlling the throttle valve 14 and the bypass valve 43. For example, the memory 51B stores a target CE map, a target throttle opening map, dynamic characteristics data of the throttle valve 14, a volumetric efficiency estimation map including estimated volumetric efficiencies after the predetermined time period, and a surge determination threshold (surge determination data).

The target CE map is used for the target CE setting module 52 to set a target CE, and stored as map data in which the target CE is set for every operating state of the engine according to the depressing operation of the accelerator pedal device 4 performed by the driver, which is detected by the accelerator pedal opening sensor 31.

The target throttle opening map is used for the throttle valve opening setting module 53 to set a target opening of the throttle valve 14, and stored as map data in which the target throttle opening is set for every operating state according to the target CE.

The dynamic characteristics data of the throttle valve 14 includes chronological data of an actual opening of the throttle valve 14 in response to a command to open the throttle valve 14 at the target opening. For example, the dynamic characteristics data is acquired in advance for various operation conditions.

The volumetric efficiency estimation map is stored as map data in which a volumetric efficiency after the predetermined time period is estimated based on an estimated opening of the throttle valve 14 after the predetermined time period and various operation parameters (an engine speed, a target advancing value of the VVT 28, an intake pressure of the intake manifold 13, etc.).

The surge determination threshold is used for the surge estimating module 56 to estimate an occurrence of the surge, is set as a flow rate threshold for every compressor pressure ratio, and is referred to as a so-called surging line. A lowest flow rate of the compressor 18 at which the surge does not occur is applied as this flow rate threshold. Note that by taking into consideration a variation in the surging line of the individual compressor 18 due to the manufacturing process/conditions, change in condition over time, etc., the surge determination threshold may be set on a higher flow rate of an average surging line so as to include the variation. In this manner, the occurrence of the surge can be estimated while taking into consideration the variation in the surging line of the individual compressors 18.

The target CE setting module 52 sets the target CE based on the target CE map according to the depressing operation of the accelerator pedal device 4 performed by the driver, which is detected by the accelerator pedal opening sensor 31. Note that, when the surge estimating module 56 estimates that the surge occurs after the predetermined time period during deceleration in which the target CE is reduced, the reduction of the target CE is temporarily suppressed.

Specifically, the reduction suppression of the target CE is achieved by setting a lowest value of the target CE. In this case, the lowest value of the target CE is set to be a flow rate the same as or above a surging flow rate for not causing the surge. This surging flow rate is obtained according to the surge determination threshold, based on a compressor pressure ratio detected by the compressor pressure ratio detecting module 55. Preferably, the lowest value of the target CE is set to correspond to 1.2 times the surging flow rate at a compressor pressure ratio of the current timing.

Further, the reduction suppression of the target CE may be achieved by temporarily not reducing the target CE. In other words, a start of the reduction of the target CE may be delayed for a predetermined period of time.

The reduction of the target CE is suppressed for the predetermined time period in either of the case of setting the lowest value of the target CE and the case of delaying the start of the reduction. This predetermined time period is set to be until an opening operation of the bypass valve 43 completes, for example, 30 msec, by taking into consideration many kinds of variations that occur until the opening operation of the bypass valve 43 from the closed state completes. Alternatively, a bypass valve opening sensor may be provided to the bypass valve 43 so that the reduction of the target CE is suppressed until the bypass valve opening sensor detects the completion of the opening operation of the bypass valve 43.

The throttle valve opening setting module 53 sets the target opening of the throttle valve 14 based on the target throttle opening map according to the target CE set by the target CE setting module 52.

The throttle valve controlling module 54 controls the throttle valve 14 to achieve the target opening set by the throttle valve opening setting module 53.

The compressor flow rate estimating module 61 has a function to estimate a flow rate through the compressor 18 (compressor flow rate) for after the predetermined time period (e.g., 30 msec) based on the estimated opening of the throttle valve 14 for after the predetermined time period. The compressor flow rate estimating module 61 includes a throttle valve opening estimating submodule 62, a throttle valve upstream-downstream pressure estimating submodule 63, and a throttle valve flow rate estimating submodule 64.

The throttle valve opening estimating submodule 62 reads the dynamic characteristic data of the throttle valve 14 from the memory 51B, and estimates the opening of the throttle valve 14 for after the predetermined time period in relation to a command value of the target opening of the throttle valve 14.

The throttle valve upstream-downstream pressure estimating submodule 63 estimates pressures at positions upstream and downstream of the throttle valve 14, respectively. First, the throttle valve upstream-downstream pressure estimating submodule 63 estimates the pressure at the upstream position of the throttle valve 14 for after the predetermined time period to be the pressure detected by the pressure sensor 34. Since the pressure at the upstream position of the throttle valve 14 is kept for a while by the turbine 24 which keeps rotating for a while due to inertia even during the deceleration, the pressure for after the predetermined time period is estimated to be the pressure for the current timing.

On the other hand, the pressure at the downstream position of the throttle valve 14 is estimated based on an amount of intake air sucked into the combustion chambers 2a, which is calculated based on the estimated value of the volumetric efficiency for after the predetermined time period. The estimated value of the volumetric efficiency is read from the estimation map of the volumetric efficiency stored in the memory 51B, based on the estimated opening of the throttle valve 14 for after the predetermined time period and the various operation parameters.

The throttle valve flow rate estimating submodule 64 estimates an amount of intake air passing through the throttle valve 14 (throttle valve flow rate), based on the estimated opening of the throttle valve 14 for after the predetermined time period and the intake pressures at the upstream and downstream positions of the throttle valve 14 for after the predetermined time period, for example, by using the Bernoulli's principle. The estimated intake air amount is considered to be the amount of intake air passing through the compressor 18 for after the predetermined time period.

By considering the atmospheric pressure detected by the atmospheric pressure sensor 37 to be a pressure upstream of the compressor 18, the compressor pressure ratio detecting module 55 calculates the compressor pressure ratio based on the pressure upstream of the compressor 18 and a pressure downstream of the compressor 18 detected by the pressure sensor 34. Since the intake pressure on the upstream side of the throttle valve 14 is kept for a while even when the throttle valve 14 is closed as described above, the detected compressor pressure ratio of the current timing is considered to be the compressor pressure ratio for after the predetermined time period.

Note that, as the pressure upstream of the compressor 18, instead of the detected value by the atmospheric sensor 37, a pressure sensor may be provided between the compressor 18 and the air cleaner 16 so that pressure detected by this pressure sensor is adopted. Similarly, as the pressure downstream of the compressor 18, instead of the pressure detected by the pressure sensor 34, another pressure sensor may be provided between the compressor 18 and the intercooler 15 so that pressure detected by the pressure sensor is adopted. Thus, a more accurate compressor pressure ratio is detected.

The surge estimating module 56 reads from the memory 51B the surge determination threshold at the compressor pressure ratio for after the predetermined time period, compares the threshold with the estimated compressor flow rate for after the predetermined time period, and prompts execution of the bypass valve controlling module 57 by the processor 51A. Specifically, the surge is estimated to occur when the estimated compressor flow rate is below the surge determination threshold, and the surge is estimated not to occur when the estimated compressor flow rate is above the surge determination threshold.

The bypass valve controlling module 57 controls the bypass valve 43 to open when the surge estimating module 56 estimates that the surge occurs, and close when the surge estimating module 56 estimates that the surge does not occur.

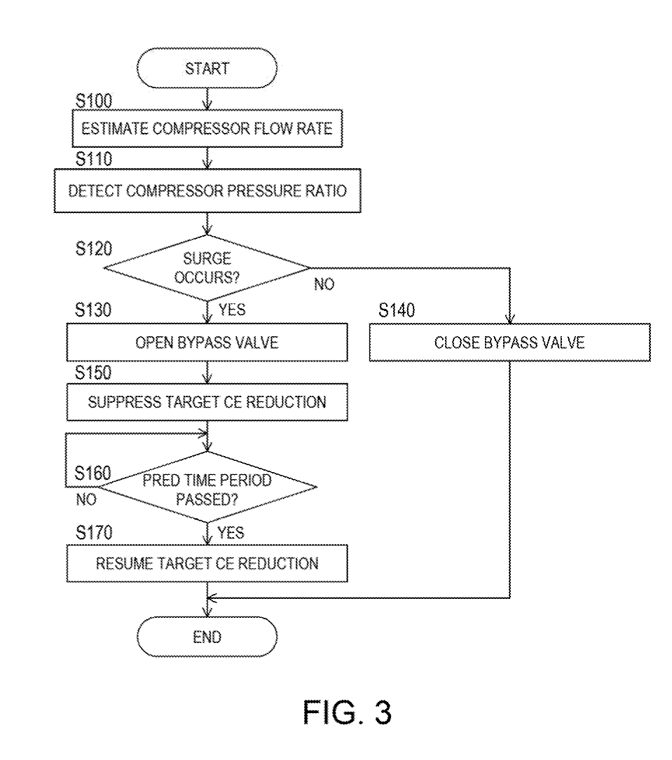

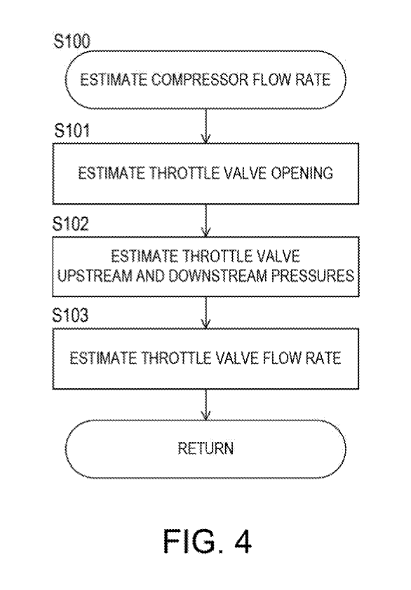

Next, the operation of the control device 60 performed when controlling the throttle valve 14 and the bypass valve 43 is described with reference to FIGS. 3 and 4. FIG. 3 is a flowchart illustrating the operation of the control device 60 performed when controlling the throttle valve 14 and the bypass valve 43. FIG. 4 is a subroutine illustrating an operation of the compressor flow rate estimating module 61 performed when estimating the compressor flow rate for after the predetermined time period.

As illustrated in FIG. 3, first, in a compressor flow rate estimating process, the compressor flow rate estimating module 61 is executed to estimate the compressor flow rate for after the predetermined time period (S100).

As illustrated in FIG. 4, in the compressor flow rate estimating process, the compressor flow rate estimating module 61 first, in a throttle valve opening estimating sub-process, prompts execution of the throttle valve opening estimating submodule 62 to estimate the opening of the throttle valve 14 for after the predetermined time period (S101). Next, in a throttle valve upstream-downstream pressure estimating sub-process, the compressor flow rate estimating module 61 prompts execution of the throttle valve upstream-downstream pressure estimating submodule 63 to estimate the pressures at the upstream and downstream positions of the throttle valve 14 for after the predetermined time period (S102). Lastly, in a throttle valve flow rate estimating sub-process, the compressor flow rate estimating module 61 prompts execution of the throttle valve flow rate estimating submodule 64 to estimate the throttle valve flow rate for after the predetermined time period and consider this flow rate to be the compressor flow rate for after the predetermined time period (S103).

Returning to FIG. 3, next, in a compressor pressure ratio detecting process, the compressor pressure ratio detecting module 55 is executed to detect the pressure ratio between the positions upstream and downstream of the compressor 18, as the compressor pressure ratio for after the predetermined time period (S110).

Next, in a surge estimating process, the surge estimating module 56 is executed to estimate the occurrence of the surge, according to the surge determination threshold stored in the memory 51B based on the estimated compressor flow rate and the compressor pressure ratio for after the predetermined time period (S120).

In a bypass valve control process, when the surge estimating module 56 estimates that the surge occurs, the bypass valve controlling module 57 opens the bypass valve 43 (S130). Thus, the pressure between the compressor 18 and the throttle valve 14 is released to the upstream side of the compressor 18 via the bypass passage 42.

Next, in a target CE reduction suppressing process, the target CE setting module 52 temporarily suppresses the reduction of the target CE (S150). Thus, the throttle valve opening setting module 53 sets a target throttle valve opening X₂ according to the target CE at which the reduction is suppressed, and the throttle valve controlling module 54 controls the throttle valve 14 to achieve the target throttle valve opening X₂.

After the predetermined time period (S160), in a target CE reduction resuming process, the target CE setting module 52 resumes the reduction of the target CE (S170). Accordingly, the throttle valve opening setting module 53 sets a target throttle valve opening X₃ according to the target CE at which the reduction is resumed, and the throttle valve controlling module 54 controls the throttle valve 14 to achieve the target throttle valve opening X₃.

On the other hand, when the surge estimating module 56 estimates that the surge does not occur, the bypass valve controlling module 57 closes the bypass valve 43 (S140). As a result, the bypass passage 42 is not opened, and thus, the pressure between the compressor 18 and the throttle valve 14 is kept without being released.

Note that the series of operations described above are performed by the control device 60, for example, every 10 msec. Therefore, every 10 msec, whether the surge occurs after the predetermined time period (e.g., 30 msec) at a compressor operating point at the corresponding timing is estimated.

According to the control device 60 having the above configuration, the following effects can be exerted.

Whether the surge occurs after the predetermined time period is estimated based on the estimated compressor flow rate and the compressor pressure ratio for after the predetermined time period. Thus, even while preventing the surge, the turbocharging pressure is easily kept by preventing the bypass valve from being opened unnecessarily. In other words, the surge prevention and an acceleration response improvement are both achieved.

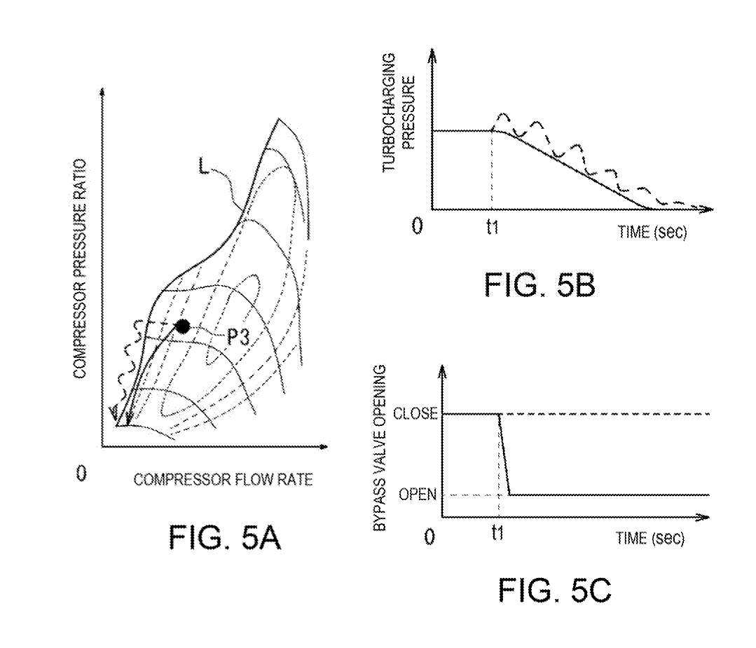

For example, as illustrated in FIG. 5A, in a case where an operating point P3 at a timing t1 at which the deceleration starts is plotted within a turbocharging range at a position close to a surging line L on a compressor map, an interval between the operating point P3 and the surging line L is short, and the operating point P3 easily reaches a surging range even by a slight decrease of the compressor flow rate for after the predetermined time period. In other words, in this case, the surge estimating module 56 easily estimates that the surge occurs after the predetermined time period.

In this case, as indicated by solid lines in FIGS. 5B and 5C, at the timing t1, the bypass valve 43 is opened and the surge is prevented. In the case where the bypass valve 43 is not opened, the surge occurs as indicated by dashed lines in FIGS. 5B and 5C.

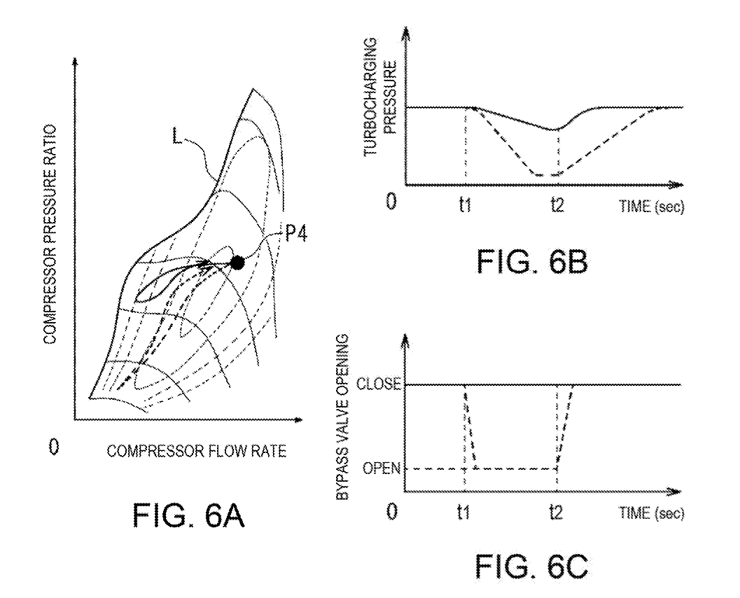

On the other hand, as illustrated in FIG. 6A, in a case where an operating point P4 of the compressor 18 before the deceleration is plotted within the turbocharging range at a position far from the surging line L on the compressor map, an interval between the operating point P4 and the surging line L is long, and the operating point P4 does not easily reach the surging range even if the compressor flow rate after the predetermined time period slightly decreases. In other words, the surge estimating module 56 does not easily estimate that the surge occurs after the predetermined time period during the deceleration in this case.

In this case, as indicated by solid lines in FIGS. 6B and 6C, at the timing t1 at which the deceleration starts, the surge is not easily estimated to occur after the predetermined time period, and therefore, the turbocharging pressure is easily kept until the engine speed is accelerated again at a timing t2 after the timing t1, and the acceleration response is improved. If the bypass valve 43 is opened at the timing t1 at which the deceleration starts, as indicated by the dashed lines in FIGS. 6B and 6C, the turbocharging pressure drops and it takes time for the turbocharging pressure to increase when the engine speed is accelerated again at the timing t2, and the acceleration response degrades.

Further, by estimating, as the compressor flow rate after the predetermined time period, the throttle valve flow rate after the predetermined time period, which is estimated based on the estimated opening of the throttle valve 14 and the pressures upstream and downstream of the throttle valve 14, the compressor flow rate after the predetermined time period is easily and accurately estimated.

Moreover, since the reduction of the target CE during the deceleration is suppressed until the opening operation of the bypass valve 43 completes, the reduction of the compressor flow rate is suppressed, and it is prevented that the operating point of the compressor 18 is located within the surging range. In other words, even while preventing the surge caused by a delay of the opening operation of the bypass valve 43, the acceleration response is improved by preventing the bypass valve 43 from being opened unnecessarily.

For example, in the case where the occurrence of the surge after 30 msec is estimated every 10 msec, depending on the estimating timing, the surge may occur within less than 30 msec. In this regard, in response to the command from the bypass valve controlling module 57 to open the bypass valve 43, the opening operation of the bypass valve 43 may delay by about 30 msec due to, for example, a response delay in the control and/or an operation delay in a mechanism of the bypass valve. In other words, if the bypass valve 43 is opened after the surge estimating module 56 estimates that the surge occurs, the bypass valve 43 may not be opened by the occurring timing of the surge.

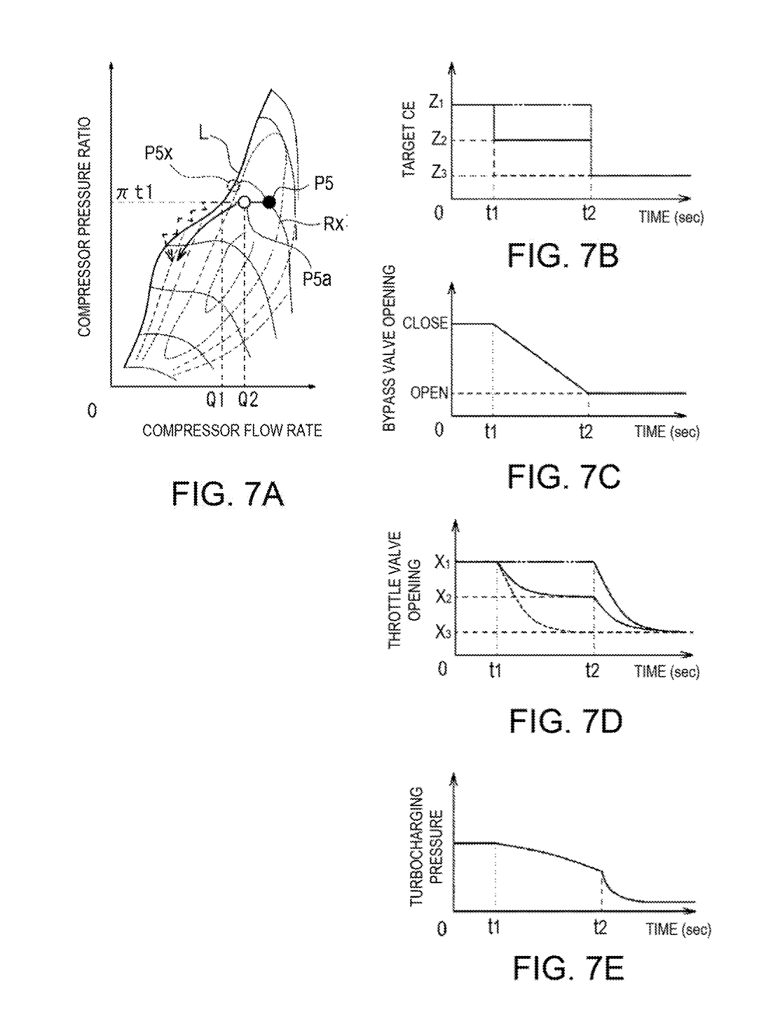

Specifically, as indicated by a dashed line in FIG. 7A, on the compressor map, depending on a location of a compressor operating point P5 during the deceleration, the compressor pressure ratio may not be reduced in time by opening the bypass valve 43 in relation to the reduction of the compressor flow rate due to the opening change of the throttle valve 14 to the narrow side, and the compressor operating point may be located within the surging range.

However, in this embodiment, when the surge is estimated to occur, the lowest value of the target CE is temporarily limited to be a value Z₂ by the target CE setting module 52 so that the compressor flow rate becomes a flow rate Q2 which is 1.2 times a surging flow rate Q1 at a compressor pressure ratio πt1 of the current timing. Thus, the reduction of the target CE is temporarily suppressed. Here, the surging flow rate Q1 is obtained according to the surge determination threshold, based on the compressor pressure ratio πt1 of the current timing. Specifically, in FIG. 7A, the surging flow rate Q1 is obtained at an intersection point of the compressor pressure ratio πt1 of the current timing with the surging line L.

Specifically, as illustrated in FIG. 7B, the reduction of the target CE from a value Z₁ at the reduction start is temporarily suppressed (limited) to the lowest value Z₂ of the reduction, instead of reducing the target CE to a value Z₃ based on the depressing operation of the accelerator pedal device 4 by the driver, which is detected by the accelerator pedal opening sensor 31.

Thus, as illustrated in FIG. 7D, the reduction of the opening of the throttle valve 14 from a value X₁ at the reduction start is temporarily suppressed to the opening X₂ which is larger than the opening X₃ corresponding to the target CE which is based on the depressing operation by the driver. As a result, as illustrated in FIG. 7A, the compressor operating point P5 is located at a compressor operating point P5a corresponding to the flow rate Q2 which is 1.2 times the surging flow rate Q1 at the compressor pressure ratio πt1 of the current timing, and therefore, the compressor operating point P5 is not located within the surging range.

Further, at the timing t2 at which the opening operation of the bypass valve 43 completes, since the reduction of the target CE is resumed, the target CE is set to be the value Z₃, and accordingly the opening of the throttle valve 14 is controlled to be X₃. Here, since the opening operation of the bypass valve 43 is completed, the turbocharging pressure sufficiently decreases as illustrated in FIG. 7E, which reduces the compressor pressure ratio. Therefore, the compressor operating point is not located within the surging range regardless of the reduction of the compressor flow rate due to the opening change of the throttle valve 14 to the narrow side.

Moreover, as indicated by a two-dotted chain line in FIG. 7B, the reduction suppression of the target CE may be achieved by temporarily delaying the reduction start. Also in this case, by the reduction suppression of the target CE, the opening change of the throttle valve 14 to the narrow side is suppressed during the reduction suppression. Therefore, the compressor flow rate is not reduced and the compressor operating point is prevented from being located within the surging range.

Also, in suppressing the reduction of the target CE, compared to delaying the reduction start of the target CE, setting the lowest value of the target CE is preferable since a deceleration sensation due to the reduction of the target CE is easier to secure and the reduction of the target CE is easier to be suppressed. Additionally, since the lowest value of the target CE is set to the flow rate the same as or above the surging flow rate Q1 at the compressor pressure ratio πt1 of the current timing, the compressor 18 is prevented from operating on the lower flow rate side of the surging line L, and the occurrence of the surge is surely suppressed.

Furthermore, by setting the lowest value of the target CE to correspond to 1.2 times the surging flow rate Q1, the compressor flow rate is not set excessively high. Thus, a degradation of the deceleration sensation during the deceleration is suppressed. Additionally, since there is an allowance on the higher flow rate side of the surging line L, even in consideration of a variation in surging line L of the individual compressor due to the manufacturing process/conditions, change in condition over time, etc., the compressor operating point is still located on the higher flow rate side of the surging line L, and therefore, the surge is surely prevented.

In this embodiment, the surging flow rate Q1 is obtained at the intersection point of the compressor pressure ratio π1 of the current timing with the surging line L. Alternatively, in a case where an even rotational speed line Rx of the compressor is stored along with the surge determination threshold, the surging flow rate Q1 may be obtained at an intersection point P5x which is obtained by shifting the compressor operating point P5 of the current timing to the lower flow rate side along the even rotational speed line Rx until intersecting with the surging line L.

Thus, a transition of the compressor operating point during the deceleration is easily estimated more accurately, and the surging flow rate is obtained more accurately. Therefore, the occurrence of the surge is suppressed more easily, and the bypass valve 43 is prevented more surely from being opened unnecessarily. Note that, in this embodiment, since the occurrence of the surge is estimated every short period of time (e.g., 10 msec), the occurrence of the surge is always estimated based on a latest compressor operating point.

### Second Embodiment

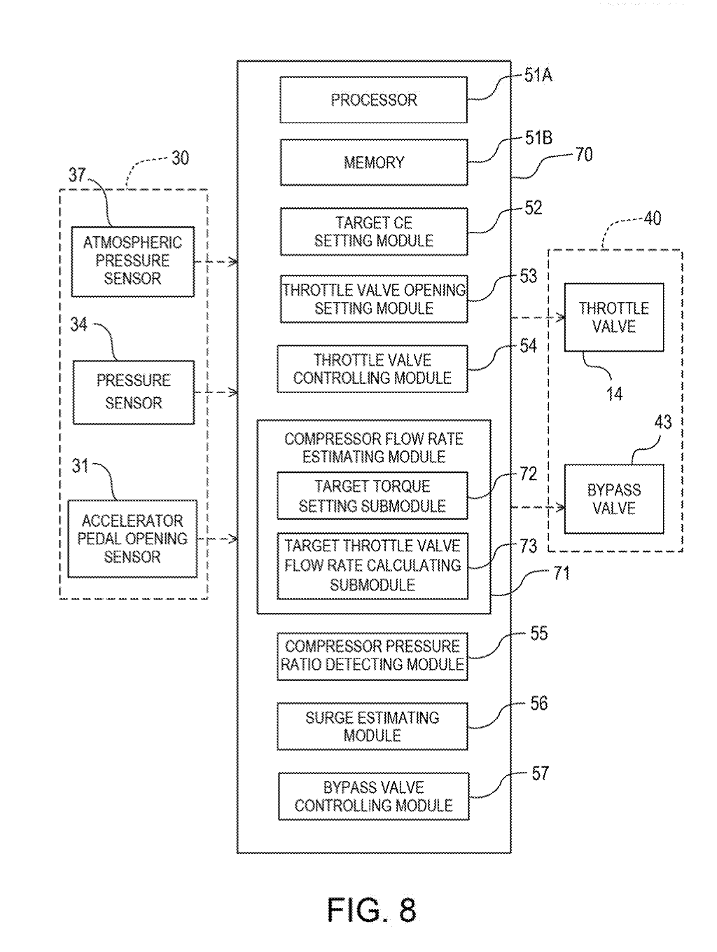

A turbocharging system of a turbocharged engine according to a second embodiment, compared to the first embodiment, includes a control device 70 instead of the control device 60 and is provided with a different compressor flow rate estimating process. As illustrated in FIG. 8, the control device 70 estimates the occurrence of the surge based on an input signal from the input device 30, and opens and closes the output device 40.

The control device 70, compared to the control device 60, includes a compressor flow rate estimating module 71 different from the compressor flow rate estimating module 61, and is otherwise similar to the first embodiment.

The compressor flow rate estimating module 71 estimates a flow rate through the compressor 18 for after a predetermined period of time (e.g., 30 msec) from a current timing, based on a target torque set according to a depressing operation of the accelerator pedal device 4 by the driver. The compressor flow rate estimating module 71 includes a target torque setting submodule 72 and a target throttle valve flow rate calculating submodule 73.

The target torque setting submodule 72 sets the target torque of the engine based on a required acceleration detected based on the depressing operation of the accelerator pedal device 4 by the driver. The target throttle valve flow rate calculating submodule 73 calculates a target flow rate through the throttle valve 14 based on various operation parameters (an in-cylinder average effective pressure, a thermal efficiency, a heat generation amount, a charging efficiency, an engine speed, etc.), so as to achieve the target torque. Further, the target throttle valve flow rate calculated by the target throttle valve flow rate calculating submodule 73 is considered to be a flow rate through the compressor 18 for after the predetermined time period.

The control device 70 estimates the occurrence of the surge according to the surge determination threshold read from the memory 51B, based on the compressor flow rate estimated for after the predetermined time period by the compressor flow rate estimating module 71, and a compressor pressure ratio detected for after the predetermined time period by the compressor pressure ratio detecting module 55. The bypass valve 43 is opened and closed by the bypass valve controlling module 57 based on the estimated result.

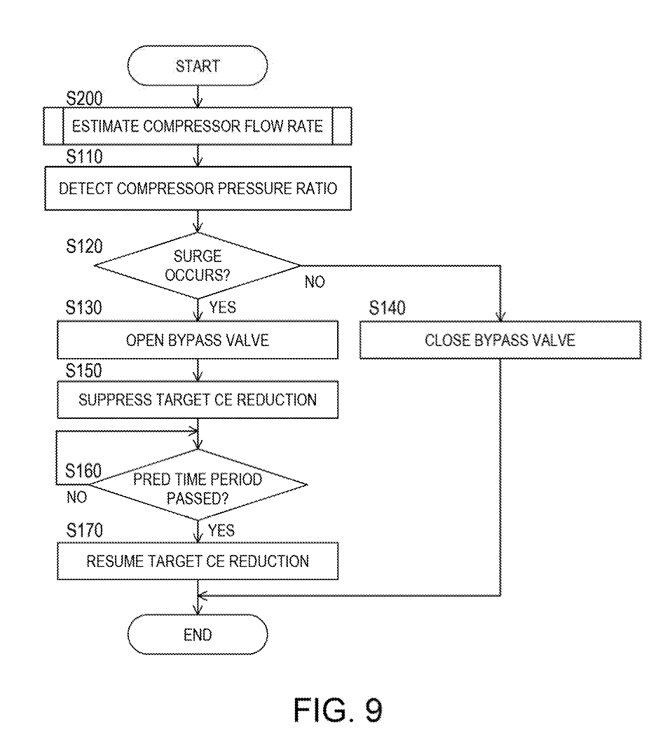

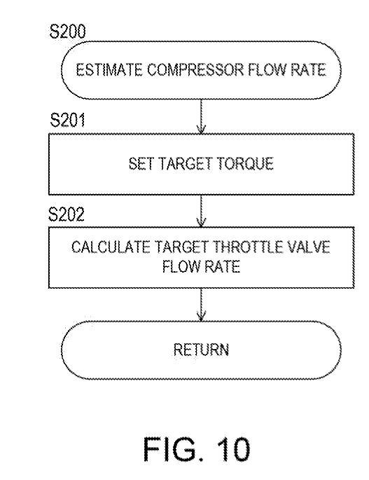

Next, an operation of the control device 70 is described with reference to FIGS. 9 and 10. FIG. 9 is a flowchart illustrating the operation of the control device 70. FIG. 10 is a subroutine illustrating the operation of the compressor flow rate estimating module 71.

As illustrated in FIG. 9, first in a compressor flow rate estimating process, the compressor flow rate estimating module 71 is executed to estimate the compressor flow rate for after the predetermined time period (S200).

As illustrated in FIG. 10, in the compressor flow rate estimating process, the compressor flow rate estimating module 71 first, in a target torque setting sub-process, prompts execution of the target torque setting submodule 72 to set the target torque according to the required acceleration based on the depressing operation of the accelerator pedal device 4 by the driver (S201). Next, in a target throttle valve flow rate calculating sub-process, the compressor flow rate estimating module 71 prompts execution of the target throttle valve flow rate calculating submodule 73 to calculate a target flow rate through the throttle valve 14 based on the target torque and consider it to be the estimated compressor flow rate for after the predetermined time period (S202).

Returning to FIG. 9, operations (S110 to S170) performed after S202 are similar to S110 to S170 of the control device 60 of the first embodiment, and therefore, description thereof is omitted.

According to the control device 70 having the above configuration, the following effects can be exerted.

The operating status of the compressor 18 after the predetermined time period is estimated based on the depressing operation received by the accelerator pedal device 4, and similar to the first embodiment, whether the surge occurs after the predetermined time period can be estimated. Additionally, by considering as the estimated compressor flow rate the target throttle valve flow rate calculated based on the acceleration request by the driver, the occurrence of the surge is estimated instantly based on a will of the driver.

In other words, for example, when operation delays of the throttle valve 14 etc. which practically occur are taken into consideration, the target flow rate of the throttle valve 14 in relation to the target opening of the throttle valve 14 may be considered to be the flow rate through the throttle valve 14 at a timing which is after a current timing by a period of time corresponding to the operation delay. Thus, the operating point of the compressor 18 after the predetermined time period is accurately estimated, and the occurrence of the surge after the predetermined time period is suitably be estimated.

### Third Embodiment

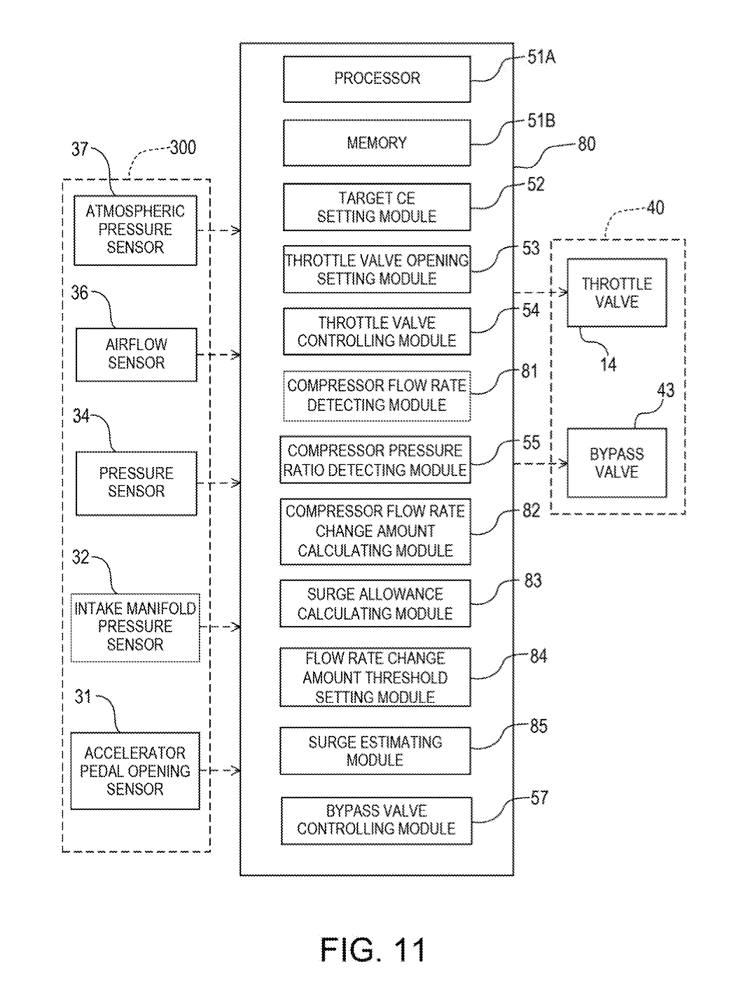

A turbocharging system of a turbocharged engine according to a third embodiment, compared to the first embodiment, includes an input device 300 instead of the input device 30, and a control device 80 instead of the control device 60, and is provided with a different surge estimating process. As illustrated in FIG. 11, the control device 80 calculates a surge allowance based on an input signal from the input device 300, estimates whether a surge occurs after a predetermined period of time (e.g., 30 msec) from a current timing based on the surge allowance, and opens and closes the bypass valve 43 of the output device 40 based on the estimated result.

The input device 300 includes an atmospheric pressure sensor 37, an intake manifold pressure sensor 32, a pressure sensor 34, an airflow sensor 36, and an accelerator pedal opening sensor 31.

The control device 80, compared to the control device 60, includes a compressor flow rate detecting module 81, a compressor flow rate change amount calculating module 82, a surge allowance calculating module 83, a flow rate change amount threshold setting module 84, and a surge estimating module 85, instead of the compressor flow rate estimating module 61 and the surge estimating module 56.

The compressor flow rate detecting module 81 detects a flow rate through the compressor based on an intake air amount detected by the airflow sensor 36. The compressor flow rate change amount calculating module 82 calculates, per unit time, a change amount of the compressor flow rate detected by the compressor flow rate detecting module 81.

The surge allowance calculating module 83 calculates as a surge allowance an interval between the detected compressor flow rate and the surge determination threshold (surging flow rate) read from the memory 51B, at a compressor pressure ratio detected by the compressor pressure ratio detecting module 55. The flow rate change amount threshold setting module 84 sets a flow rate change amount threshold according to the surge allowance. Specifically, the flow rate change amount threshold is set to increase as the surge allowance increases.

The surge estimating module 85 estimates whether the surge occurs after the predetermined time period based on the flow rate change amount and the flow rate change amount threshold. Specifically, based on the calculated surge allowance and the calculated flow rate change amount, the surge is estimated to occur when a surge allowance after the predetermined time period is estimated to be negative, whereas the surge is estimated not to occur when the surge allowance after the predetermined time period is estimated to be positive. Next, based on the estimated result by the surge estimating module 85, the bypass valve 43 is opened and closed by the bypass valve controlling module 57.

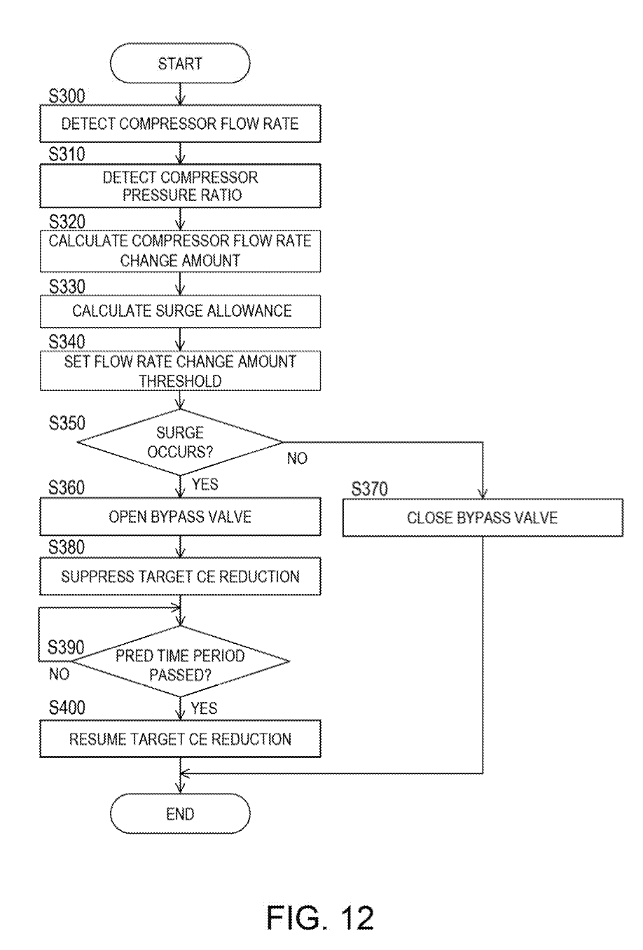

Next, the operation of the third embodiment is described with reference to FIG. 12. FIG. 12 is a flowchart illustrating the operation of the control device 80. As illustrated in FIG. 12, first in a compressor flow rate detecting process, the compressor flow rate detecting module 81 detects the flow rate through the compressor (S300). Next, in a compressor pressure ratio detecting process, the compressor pressure ratio detecting module 55 detects the compressor pressure ratio (S310). In a compressor flow rate change amount calculating process, the compressor flow rate change amount calculating module 82 calculates the change amount of the compressor flow rate per unit time (S320).

Next, in a surge allowance calculating process, the surge allowance calculating module 83 calculates the surge allowance (S330). In a change amount threshold setting process, the flow rate change amount threshold setting module 84 sets the flow rate change amount threshold (S340). In a surge estimating process, the surge estimating process module 85 estimates whether the surge occurs after the predetermined time period (S350).

Since operations (S360 to S400) performed after S350 are similar to S130 to S170 of the control device 60 of the first embodiment, description thereof is omitted.

According to the control device 80 having the above configuration, the following effects can be exerted.

The occurrence of the surge is estimated based on the surge allowance and the flow rate change amount which are calculated based on the operating status of the compressor 18 of the current timing, without estimating the flow rate through the compressor 18.

Since the flow rate change amount threshold is set to increase as the surge allowance increases, when the surge allowance is large, the flow rate change amount threshold is set high so that the surge is not easily estimated to occur, and thus, the bypass valve 43 is prevented from being opened unnecessarily. On the other hand, when the surge allowance is small, the flow rate change amount threshold is set low so that the surge is easily estimated to occur, and thus, the bypass valve 43 is easily opened and the surge is easily prevented. As a result, the bypass valve 43 is prevented from being opened unnecessarily while preventing the surge.

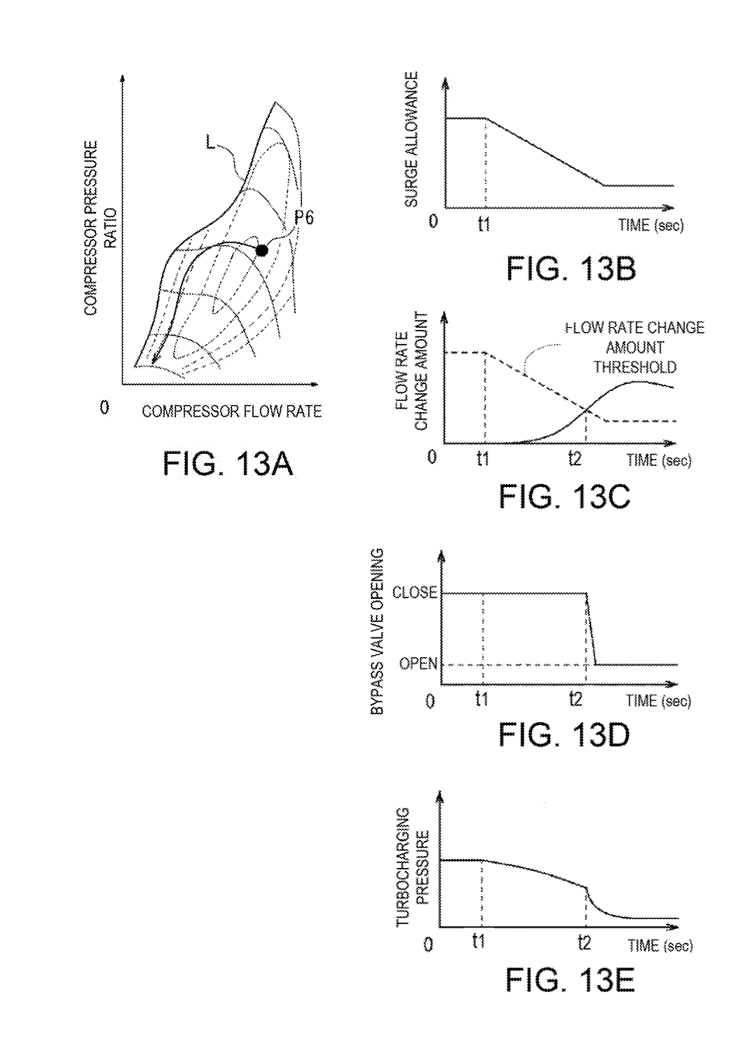

FIGS. 13A to 13E illustrate transitions of various data when the deceleration control is performed at the timing t1. The transition of a compressor operating point P6 is illustrated in FIG. 13A, a transition of the surge allowance is illustrated in FIG. 13B, a transition of the flow rate change amount threshold for the surge estimation is indicated by a dashed line and a transition of the flow rate change amount is indicated by a solid line in FIG. 13C, a transition of the operation of the bypass valve is illustrated in FIG. 13D, and a transition of the turbocharging pressure is illustrated in FIG. 13E.

As illustrated in FIG. 13A, at the timing t1 at which the deceleration starts, the compressor operating point P6 is far from the surging line L. Therefore, the surge allowance becomes large as illustrated in FIG. 13B, and the flow rate change amount threshold is set high as indicated by the dashed line in FIG. 13C. When the deceleration control is performed in this state, the compressor operating point P6 shifts to the lower flow rate side while keeping the pressure ratio as illustrated in FIG. 13A. Therefore, the surge allowance decreases as illustrated in FIG. 13B.

Further, as illustrated in FIG. 13C, the flow rate change amount threshold decreases corresponding to the reduction of the surge allowance. Meanwhile, the flow rate change amount increases due to the deceleration control, and upon exceeding the flow rate change amount threshold at the timing t2, the bypass valve 43 is opened as illustrated in FIG. 13D, and the turbocharging pressure between the compressor 18 and the throttle valve 14 decreases as illustrated in FIG. 13E. In this manner, even while preventing the surge, the turbocharging pressure is easily kept by preventing the bypass valve 43 from being opened unnecessarily.

The present invention is not limited to the above illustrative embodiments, and it is needless to say that various enhancements and various modifications in design can be made without departing from the scope of the present invention.

As described above, according to the present invention, an acceleration response is improved even while preventing a surge which occurs due to a delay in opening a bypass valve. Therefore, the present invention may suitably be used in the fields of manufacturing industries of this type of turbocharged engines.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### LIST OF REFERENCE CHARACTERS

1 Turbocharging System
2 Engine
3 Turbocharger
4 Accelerator Pedal Device
5 Controller
13 Intake Manifold
14 Throttle Valve
15 Intercooler
16 Air Cleaner
18 Compressor
24 Turbine
31 Accelerator Pedal Opening Sensor
32 Intake Manifold Pressure Sensor
34 Pressure Sensor
36 Airflow Sensor
37 Atmospheric Pressure Sensor
42 Bypass Passage
43 Bypass Valve
51B Memory
52 Target Air Charge Amount Setting Module
53 Throttle Valve Opening Setting Module
54 Throttle Valve Controlling Module
55 Compressor Pressure Ratio Detecting Module
56 Surge Estimating Module
57 Bypass Valve Controlling Module
60 Control Device
61 Compressor Flow Rate Estimating Module

What is claimed is:

1. A control system of a turbocharged engine including a turbocharger having a compressor disposed in an intake passage, a bypass passage for bypassing the compressor in the intake passage, and a bypass valve provided to the bypass passage and for opening and closing the bypass passage, the control system comprising a processor configured to execute:
a surge estimating module for estimating an occurrence of a surge;
a bypass valve controlling module for opening the bypass valve when the surge estimating module estimates that the surge occurs; and
a target air charge amount setting module for suppressing, when the bypass valve controlling module opens the bypass valve, a reduction of a target air charge amount until the opening operation of the bypass valve completes.

2. The control system of claim 1, wherein the processor is further configured to execute:
a throttle valve opening estimating module for estimating an opening of a throttle valve for after a predetermined period of time from a current timing based on a target opening of the throttle valve that is set corresponding to an acceleration request from a vehicle driver;
a throttle valve upstream-downstream pressure estimating module for estimating a pressure at a position upstream of the throttle valve and a pressure at a position downstream of the throttle valve, for after the predetermined time period;
a throttle valve flow rate estimating module for estimating a flow rate through the throttle valve for after the predetermined time period, based on the estimated opening of the throttle valve and the estimated pressures at the positions upstream and downstream of the throttle valve;
a compressor flow rate estimating module for acquiring the estimated throttle valve flow rate as a flow rate through the compressor; and
a compressor pressure ratio detecting module for detecting a pressure ratio between positions upstream and downstream of the compressor, and
wherein the surge estimating module estimates the occurrence of the surge according to surge determination data based on the estimated compressor flow rate and the detected compressor pressure ratio.

3. The control system of claim 1, wherein executing the target air charge amount setting module suppresses the reduction of the target air charge amount by setting a lowest value of the target air charge amount.

4. The control system of claim 3, wherein the lowest value corresponds to a flow rate that is the same as or above a surging flow rate obtained according to surge determination data, based on a compressor pressure ratio.

5. The control system of claim 4, wherein the lowest value corresponds to a flow rate that is 1.2 times the surging flow rate.

6. A control system of a turbocharged engine including a turbocharger having a compressor disposed in an intake passage, a bypass passage for bypassing the compressor in the intake passage, and a bypass valve provided to the bypass passage and for opening and closing the bypass passage, the control system comprising a processor configured to execute:
a surge estimating module for estimating an occurrence of a surge;
a bypass valve controlling module for opening the bypass valve when the surge estimating module estimates that the surge occurs; and
a target air charge amount setting module for setting a target air charge amount based on an operation of an accelerator pedal performed by a vehicle driver, and suppressing, when the bypass valve controlling module opens the bypass valve, a reduction of the target air charge amount caused when the operation of the accelerator pedal is changed, until the opening operation of the bypass valve completes, the operation of the accelerator pedal detected by an accelerator pedal opening sensor.

7. A control system of a turbocharged engine including a turbocharger having a compressor disposed in an intake passage, a bypass passage for bypassing the compressor in the intake passage, and a bypass valve provided to the bypass passage and for opening and closing the bypass passage, the control system comprising a processor configured to execute:
a surge estimating module for estimating an occurrence of a surge;
a bypass valve controlling module for opening the bypass valve when the surge estimating module estimates that the surge occurs; and
a target air charge amount setting module for setting a target air charge amount based on an operation of an accelerator pedal performed by a vehicle driver, and suppressing, when the bypass valve controlling module opens the bypass valve, a reduction of the target air charge amount caused during deceleration of the engine, until the opening operation of the bypass valve completes, the operation of the accelerator pedal detected by an accelerator pedal opening sensor.
